(19) United States
(12) Patent Application Publication
(10) Pub. No.: US 2019/0233257 A1
(43) Pub. Date: Aug. 1, 2019

(54) Multi-Winch Lifting Apparatus

(71) Applicants: David R. Hall, Provo, UT (US); Daniel Madsen, Vineyard, UT (US); Nathan Davis, Bountiful, UT (US)

(72) Inventors: David R. Hall, Provo, UT (US); Daniel Madsen, Vineyard, UT (US); Nathan Davis, Bountiful, UT (US)

(21) Appl. No.: 15/886,019

(22) Filed: Feb. 1, 2018

(51) Int. Cl. B66C 11/20; B66D 1/60; B66C 13/40; B66C 21/00

(52) U.S. Cl. CPC B66C 11/20; B66D 1/60; B66C 2700/011; B66C 21/00; B66D 2700/0141; B66C 13/40

(57) ABSTRACT

Devices, systems, and methods for a multi-winch lifting apparatus and load movement are disclosed. The lifting apparatus includes a mounting base. At least two lateral winches are attached to the mounting base. Each of these lateral winches includes its own lateral line. A lifting winch is also attached to the mounting base. The lifting winch also includes a lifting line.

### TECHNICAL FIELD

The devices, systems, and methods described herein relate generally to winches. More particularly, the devices, systems, and methods described herein relate to load movement using multiple winches.

### BACKGROUND

Movement of loads is important in every industry. Cranes, winches, elevators, and many other devices are used to lift and move loads from one point to another. Equipment movement can become difficult when done in spaces without room for large equipment, in areas where lateral movement is needed but the infrastructure isn't present, or in places where heavy equipment is not allowed for safety or aesthetics.

Moving loads in places with limited space, limited infrastructure, and restrictions on heavy equipment can be challenging. For example, construction of a playground in a park may necessitate lifting heavy parts into place. These parts may be too heavy or awkward to lift manually. Bringing a truck, crane, or other mobile equipment may be precluded by limited space for passage of the equipment, or the grounds may be fully developed and vehicle movement across the grounds would cause major damage to the park. In these instances, expensive solutions can solve the issue, such as renting an extremely large crane. Sometimes, dangerous solutions may be tried, such as perching precariously in unsafe locations or manually lifting the loads.

### SUMMARY

Devices, systems, and methods for a multi-winch lifting apparatus and load movement are disclosed. The lifting apparatus includes a mounting base. At least two lateral winches are attached to the mounting base. Each of these lateral winches includes its own lateral line. A lifting winch is also attached to the mounting base. The lifting winch also includes a lifting line.

Preferably, the lifting apparatus includes at least three lateral winches attached to three different sides of the mounting base and the lateral lines of the three lateral winches are each adapted to be attached to a separate elevated point such that the lifting winch can be held above an operating area. Preferably, the lifting apparatus also includes a controller adapted to operate each of the three lateral winches. The controller extends and retracts the lateral lines as appropriate to thereby move the lifting winch to different points above the operating area. Preferably, the controller is also adapted to control the lifting winch. As a result, the lifting apparatus is able to lift a load from one location on the operating area, move the lifted load laterally and then lower the load to a different location on the operating area.

Alternatively, the lifting apparatus includes only two lateral winches and a controller which extends and retracts the lines from the lateral winches so as to move the mounting base along a generally linear path.

Preferably, the lifting apparatus also includes a top winch attached to the mounting base. The top winch includes a top line, which can be attached to a point above the mounting base. Consequently, the top winch can be used to stabilize and control the vertical position of the mounting base.

Each of the three lateral winches and the lifting winch may have one or more motors. The motors may be located in an interior volume of their respective winch. The lifting apparatus may use one or more communication systems. These may include Bluetooth communication chips, Internet Wi-Fi transceivers, network transceivers, a Z-Wave network transceiver, or a combination thereof. The one or more communication systems may communicate with an external remote control device. The one or more communication systems may receive instructions from the external remote control device, generate signals instructing each of the one or motors to rotate at a speed and in a direction, receive signals from each of the one or more motors regarding motor statuses, and generate a signal informing the external remote control device of the motor statuses.

In some embodiments, the lifting apparatus may be powered by one or more batteries. In other embodiments, the lifting apparatus may be powered by an electrical power line.

In accordance with the method aspect of the invention, a method for moving loads, includes attaching at least two lateral lines from at least two lateral winches to at least two elevated points, the at least two lateral winches mounted to a mounting base. A lifting line of a lifting winch, which is itself attached to the mounting base, is also attached to a load. The load is lifted by the lifting winch, and then moved laterally by extending and retracting the lateral lines, as appropriate. The load is then lowered to the desired destination.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative, and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIGS. 1A-C are perspective views of a lifting apparatus moving a load.

FIGS. 2A-D show various views of a horizontally-oriented lifting apparatus.

FIGS. 3A-D show various views of a vertically-oriented lifting apparatus.

FIG. 4 shows an isometric top-front view of the lifting apparatus of FIG. 2A with an added top winch.

FIG. 5 shows a method for moving loads.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “winch” is meant to refer to a device consisting of a cable, rope or chain winding around a rotating drum, preferably turned by a motor.

As used herein, “lateral” when used to describe movement is meant to refer to movements in a generally horizontal direction.

It will be readily understood that the components of the described devices, systems, and methods, as generally described and illustrated in the Figures herein, could be arranged and designed in a wide variety of different configurations. Thus, the following more detailed description of the embodiments of the described devices, systems, and methods, as represented in the Figures, is not intended to limit the scope of the described devices, systems, and methods, as claimed, but is merely representative of certain examples of presently contemplated embodiments in accordance with the described devices, systems, and methods.

A lifting assembly is presented that utilizes multiple lateral winches mounted, preferably to the sides of a central mounting base and a lifting winch that is mounted, preferably to the bottom of the central mounting base. The lateral lines of each of the lateral winches are attached to elevated points around the area within which the load is located and the destination. In the example of the park, these may be nearby buildings, flagpoles, or trees. The lateral winches extend and pull back concurrently so that the lifting assembly travels around the area. The lifting winch is then attached to the parts, the parts are lifted, and the lifting assembly travels to the destination, elevating the load or lowering the load as needed.

The figures shown all utilize three lateral winches. However, in some embodiments, two lateral winches may be used for movement of loads in a single line. In other embodiments, more than three lateral winches may be used for greater stability or finer movement control.

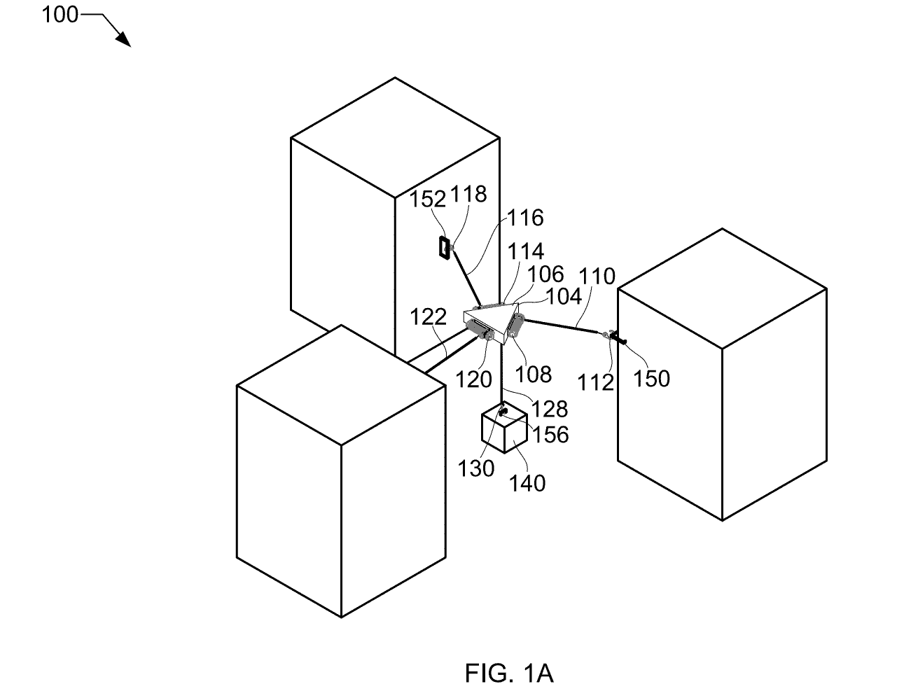

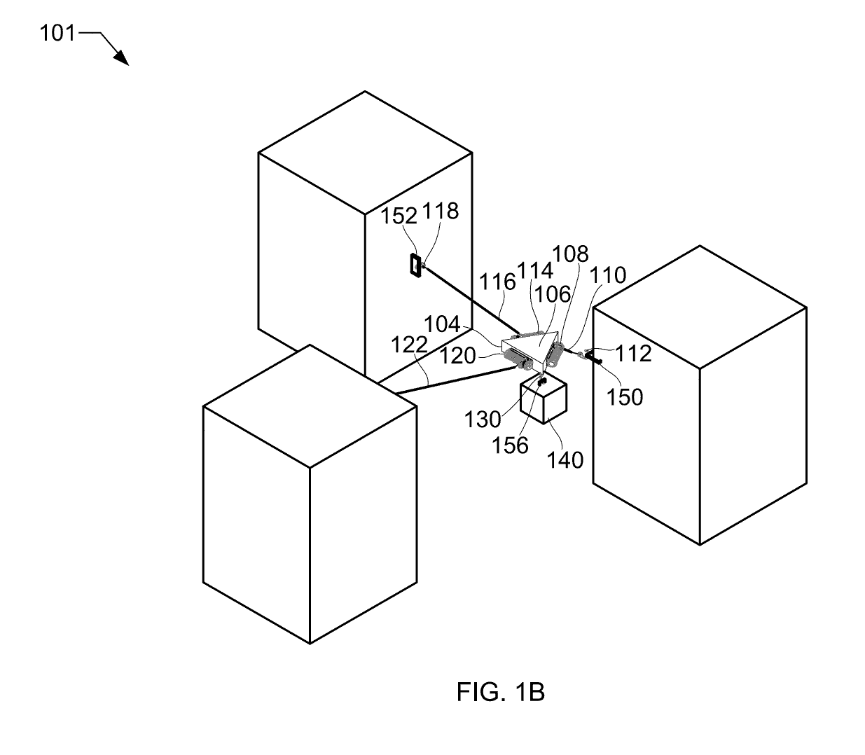

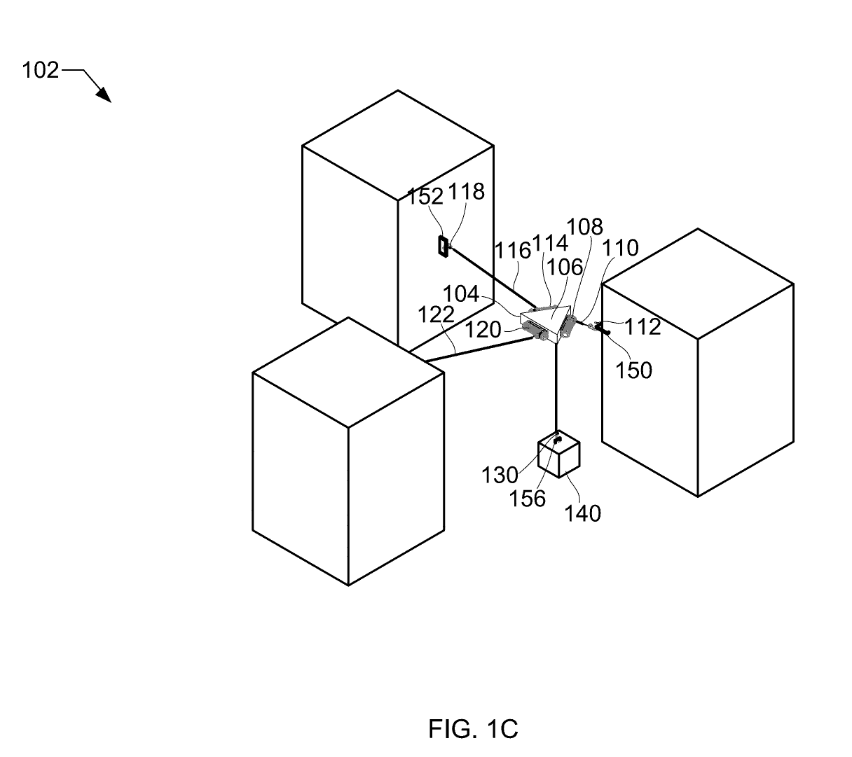

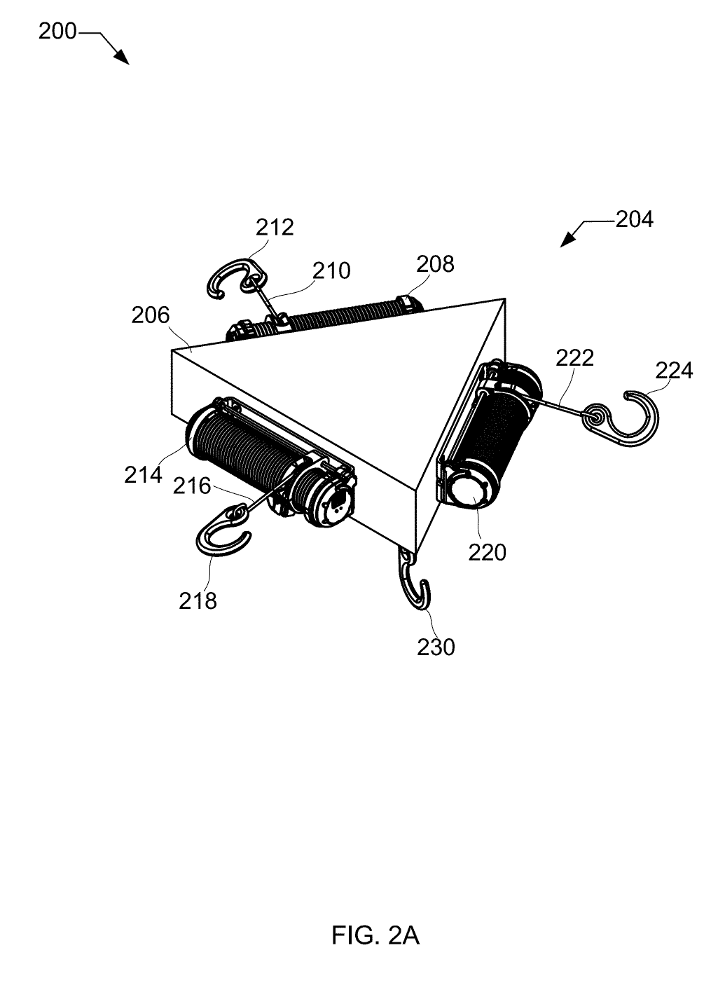

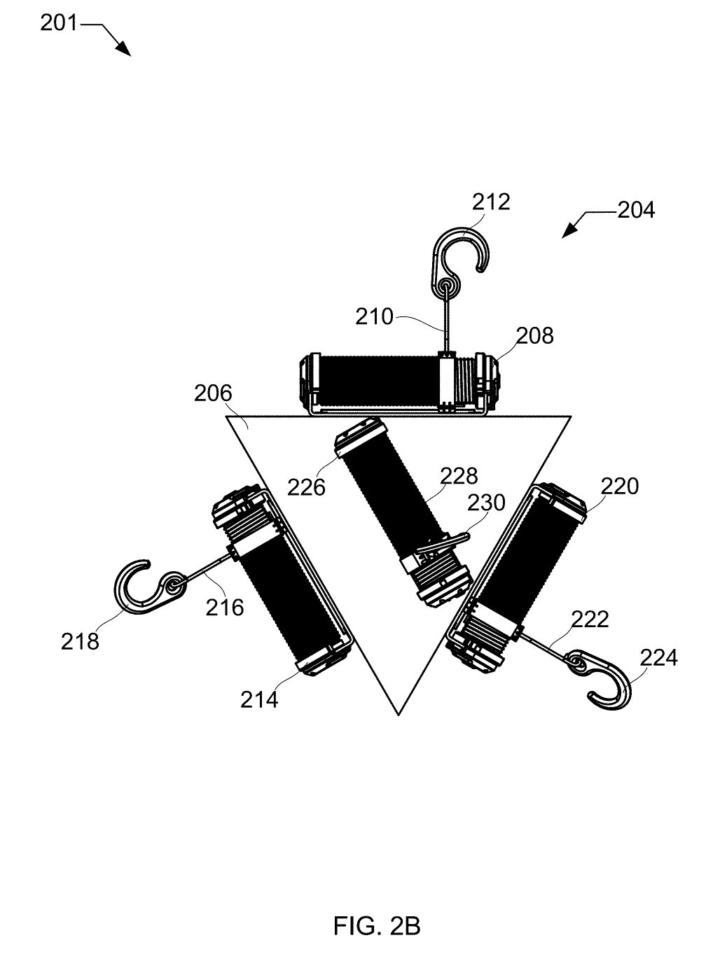

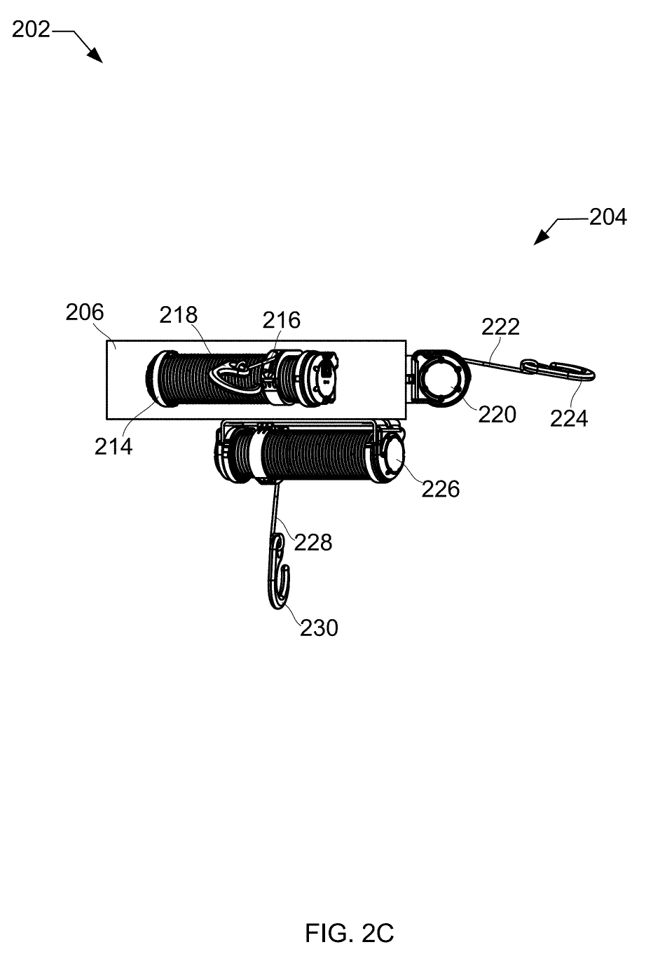

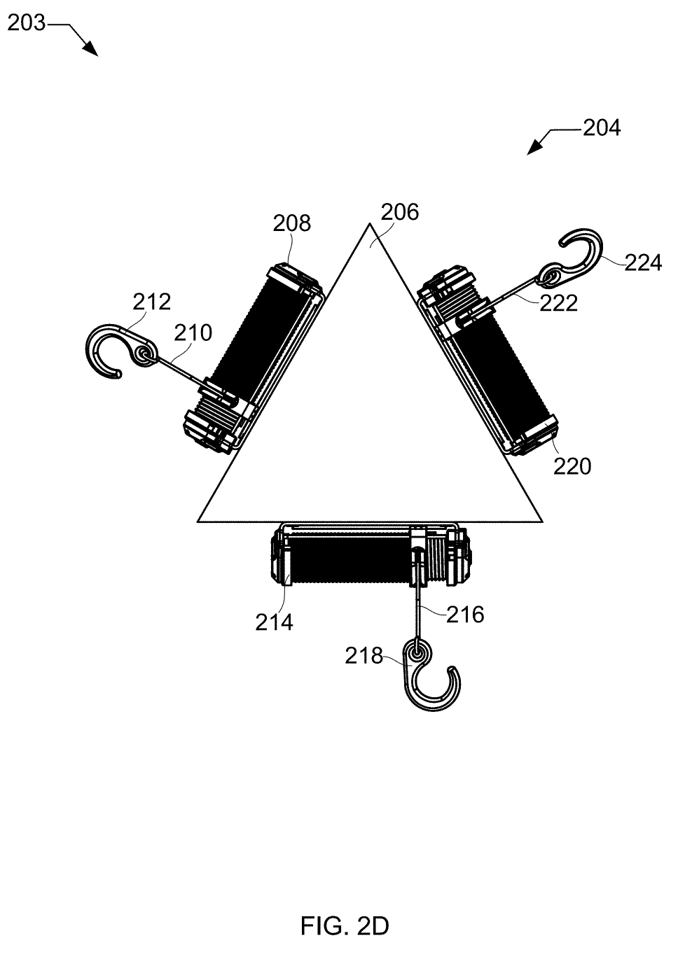

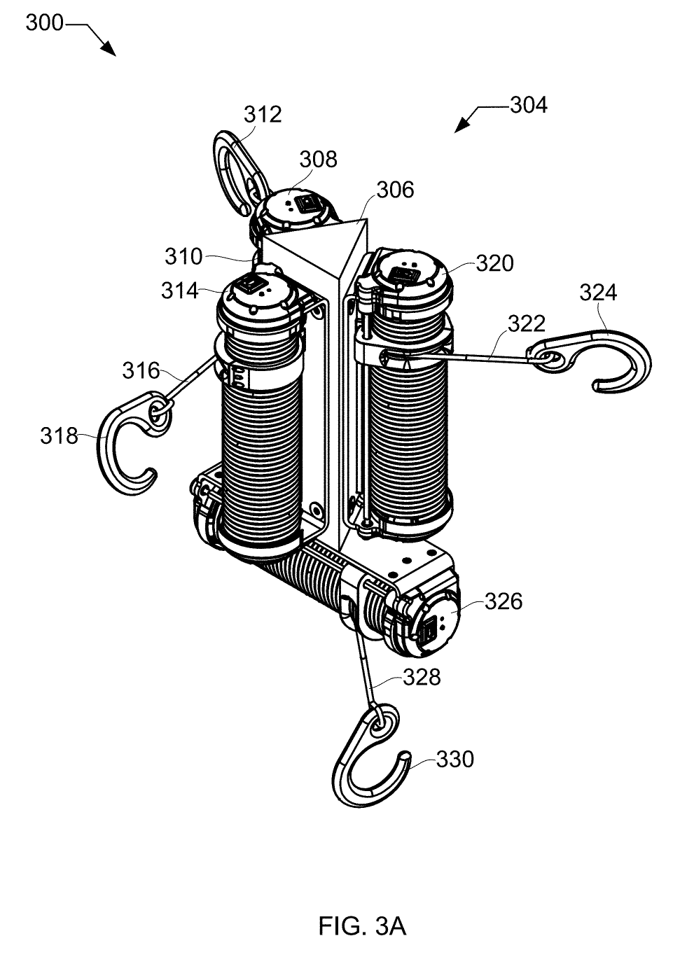

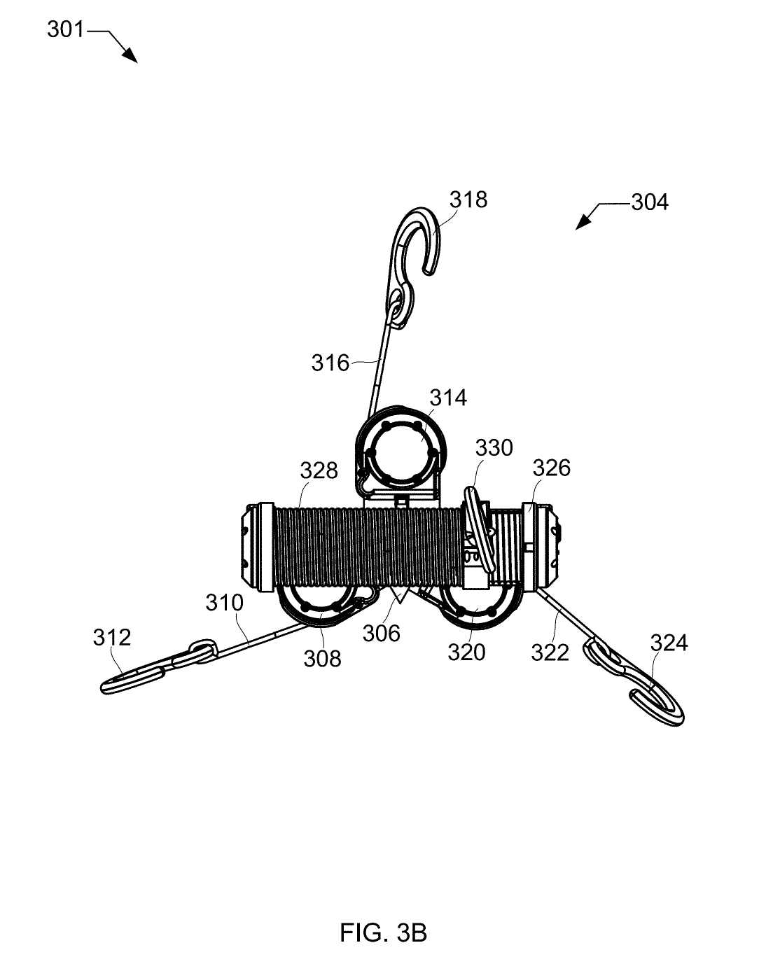

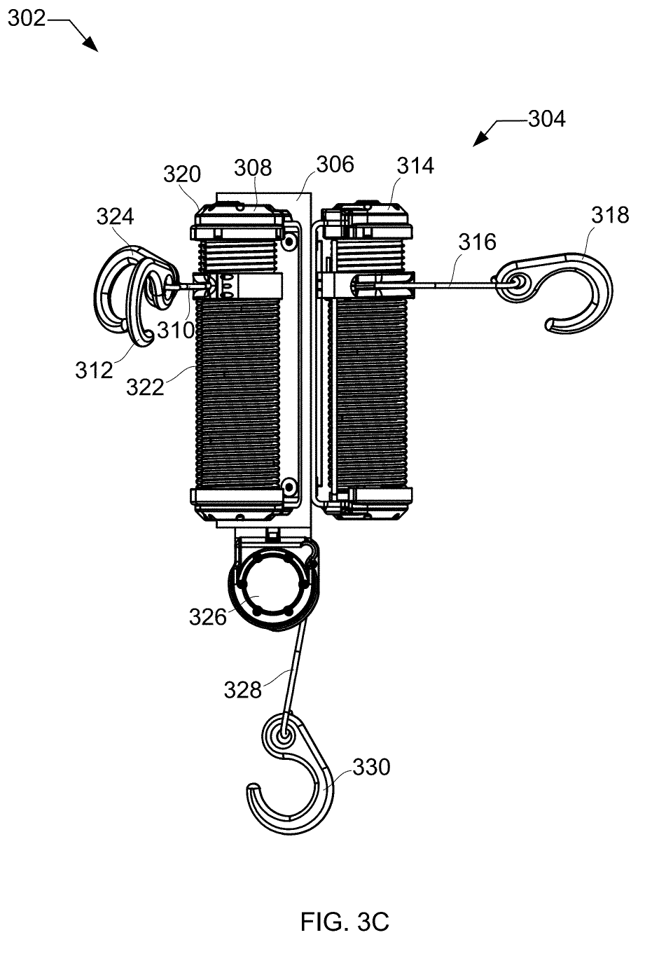

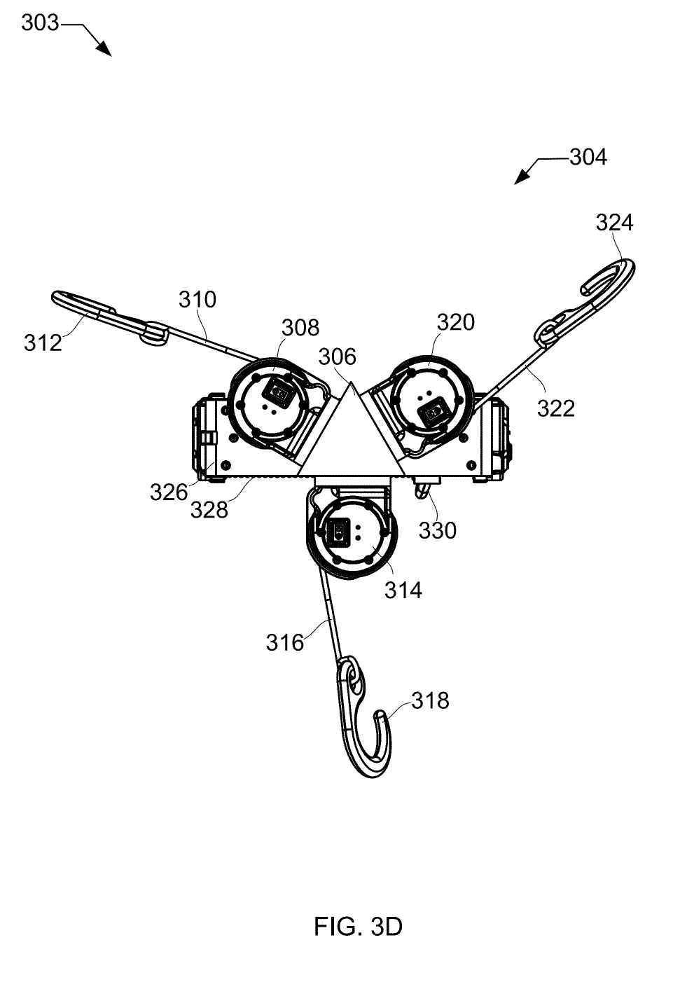

Referring now to the Figures, FIGS. 1A-C show perspective views of a scenario involving lifting a load using the described devices, systems, and methods. FIG. 1A is a top front isometric perspective view 100 of a lifting apparatus 104 attached to the load 140 before the load is lifted. FIG. 1B is a top front isometric perspective view 101 of the load 140 being moved to the destination. FIG. 1C is a top front isometric perspective view 102 of the load 140 being placed at the destination. Lifting apparatus 104 is shown as the horizontally-oriented lifting apparatus 204 of FIG. 2, but may also be the vertically-oriented lifting apparatus 304 of FIG. 3, or another embodiment of the lifting apparatus. Lifting apparatus 104 has three lateral winches 108, 114, and 120, each having a lateral line 110, 116, and 122, respectively. Each winch is mounted on central mounting base 106. Each lateral line may end in a hook 112, 118, and 124, respectively.

Lifting apparatus 104 also has a lifting winch 126, with a lifting line 128 ending in a hook 130 or like connection device. Each lateral line is attached to an elevated point 150, 152, and 154 by hooks 112, 118, and 124 or similar connection device, respectively. Lifting line 128 is attached to a load 140 at attachment point 156 by hook 130. Hook 124 and elevated point 154 are not shown, as they are blocked by a building. Lifting winch 126 is not shown, as it is blocked by the rest of lifting assembly 106.

Lifting winch 126 retracts lifting line 128, lifting load 140, as shown at 100. The lifting apparatus 104 then moves to the destination by extending and retracting lateral lines 108, 114, and 120, as shown at 101. The lifting winch 126 then extends lifting line 128, lowering load 140 to the destination, as shown at 102.

Preferably, the lifting apparatus includes a controller that controls the winding and unwinding of the lateral winches. More preferably the controller also controls the lifting winch. Most preferably, the controller also controls the top winch. In this way, the extension and retraction of the several lines is synchronously controlled, to thereby provide accurate control of the movement of the load.

In some embodiments, each lateral winch 108, 114, and 120 and the lifting winch 126 may each have the capacity to pull up to 2,000 lbs. It is appreciated that the 2,000 lbs. lifting capacity is exemplary only and different lifting capacities may similarly be used. In some embodiments, one or more of the winches (e.g., 108, 114, 120, and/or 126) may have the capacity to pull up to 4,000 lbs. or more (double or triple a steady state capacity, for example) for a very short amount of time (e.g., less than 5 seconds), by allowing one or more motors of the winch (e.g., 108, 114, 120, and/or 126) to draw substantially more current (in a short burst, for example), than is permitted in steady state (or typical) operation. In some cases, this burst of pulling power may enable the winch (e.g., 108, 114, 120, and/or 126) to overcome initial static friction of a heavy object while being able to overcome the moving friction using a pulling capacity that is less than the 2,000 lb pulling capacity. This may enable the winch (e.g., 108, 114, 120, and/or 126) and/or the lifting apparatus 104 as a whole to be able to accomplish certain tasks that would otherwise be unattainable with the limited steady state capacity of one or more of the winches (e.g., 108, 114, 120, 126). In some cases, this burst mode capacity may be enabled via a button or through an application (on a mobile device, for example).

Referring now to FIGS. 2A-D, FIGS. 2A-D are various views 200-203 of a horizontally-oriented lifting apparatus 204 (i.e., 104) that may be used in the described devices, systems, and methods. Lifting apparatus 204 is referred to as “horizontally-oriented” to distinguish the orientation of the lateral winches with respect to the lifting winch. FIG. 2A is an isometric top-front view 200. FIG. 2B is an isometric bottom view 201. FIG. 2C is an isometric side view 202. FIG. 2D is an isometric top view 203. Lateral winches 208, 214, and 220 are mounted to the sides of central mounting base 206. Lifting winch 226 is mounted to the bottom of central mounting base 206. Lateral winches 208, 214, and 220 have lateral lines 220, 216, and 222, respectively, and lateral hooks 212, 218, and 224, respectively. Lifting winch 226 has lifting line 228 and lifting hook 230. In other embodiments, lateral hooks 212, 218, and 224 and lifting hook 230 are replaced by other attachment devices, including but not limited to grasping devices, magnets, hook-and-loop fasteners, carabiners, suction devices, chains, bolts, and straps.

Referring to FIGS. 3A-D, FIGS. 3A-D are various views 300-303 of a vertically-oriented lifting apparatus 304 (i.e., 104, 204) that may be used in the described devices, systems, and methods. Lifting apparatus 304 is referred to as “vertically-oriented” to distinguish the orientation of the lateral winches with respect to the lifting winch. Other than orientation of the lateral winches and the associated shape and size of the central mounting base, lifting apparatus 304 is identical to lifting apparatus 204 of FIG. 2A. FIG. 3A is an isometric top-front view 300. FIG. 3B is an isometric bottom view 301. FIG. 3C is an isometric side view 302. FIG. 3D is an isometric top view 303. Lateral winches 308, 314, and 320 are mounted to the sides of central mounting base 306. Lifting winch 326 is mounted to the bottom of central mounting base 306. Lateral winches 308, 314, and 320 have lateral lines 320, 316, and 322, respectively, and lateral hooks 312, 318, and 324, respectively. Lifting winch 326 has lifting line 328 and lifting hook 330.

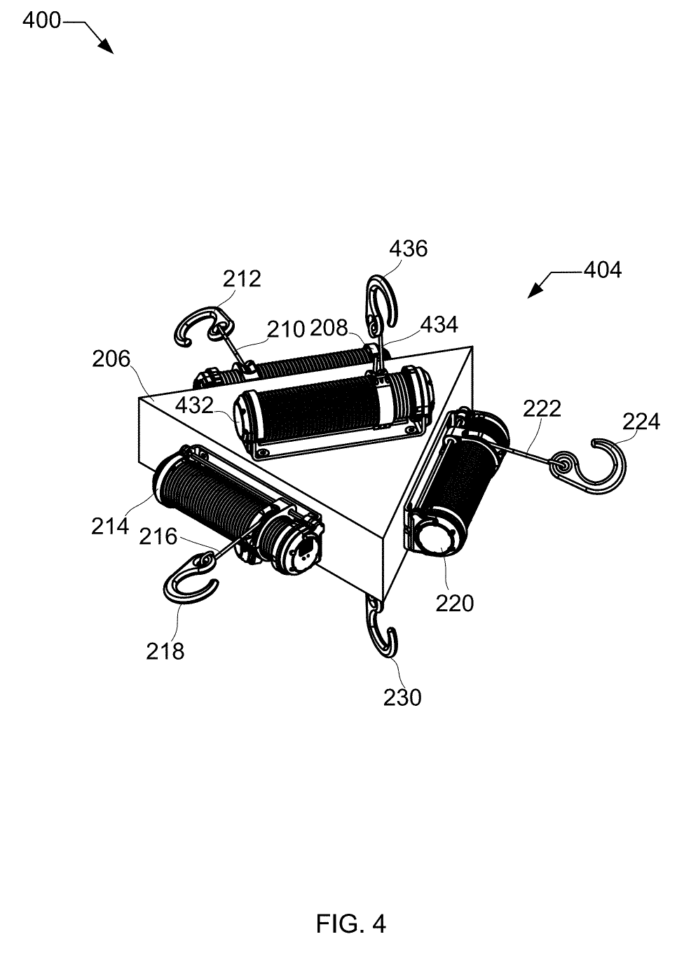

Referring to FIG. 4, FIG. 4 is an isometric top-front view of the lifting apparatus 204 of FIG. 2A with an added top winch 432 that may be used in the described devices, systems, and methods. Lifting apparatus 404 is lifting apparatus 204, with the addition of top winch 232. Top winch 232 comprises a top line 234 and a top hook 236. The addition of top winch 232 allows for elevation of the entire lifting apparatus. Top line 234 is attached to a point above the lifting apparatus. The entire apparatus can then be raised or returned based on elevation needs as the lifting apparatus moves around the operating area. In one example, the top line is attached to the ceiling of a warehouse with shelves of varying height. With the lateral lines attached at far corners of the warehouse, maximizing operating area, the lifting device provides a finer control on elevation.

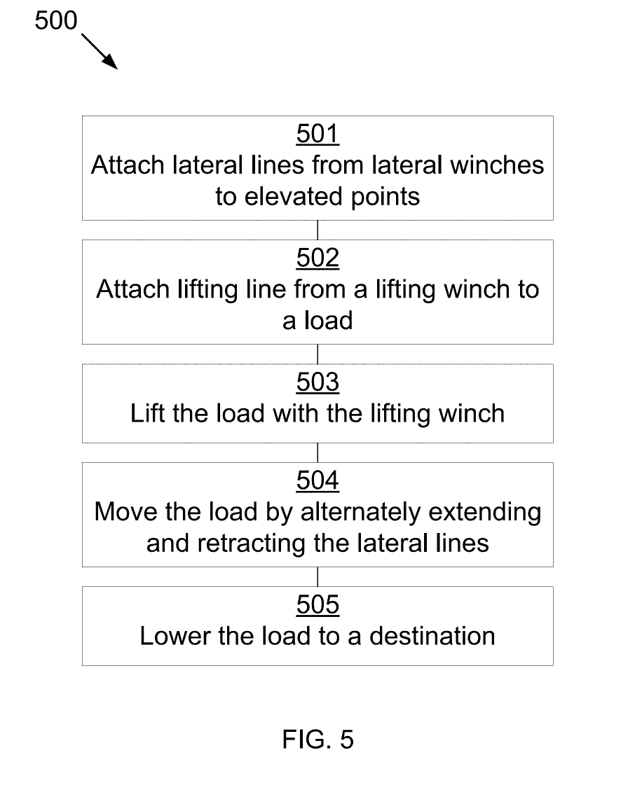

Referring to FIG. 5, FIG. 5 is a method 500 for moving a load using the described devices, and systems. At 501, lateral lines from lateral winches are attached to elevated points. The lateral winches may be mounted to sides of a central mounting base. At 502, a lifting line from a lifting winch is attached to a load. The lifting winch may be mounted to a bottom of the central mounting base. At 503, the load is lifted with the lifting winch. At 504, the load is moved by alternately extending and retracting the lateral lines. At 505, the load is lowered to a destination. The destination may be a different location from the original position of the load.

In these and other embodiments, each of the winches has one or more motors. In some embodiments, the motors are located in an interior volume of their respective winch, such as inside the spool assembly. In some embodiments, one or more of the winches may share a common motor with appropriate gearing.

In some embodiments, the lifting apparatus has one or more communication systems. These may include Bluetooth communication chips, Internet Wi-Fi transceivers, network transceivers, a Z-Wave network transceiver, or a combination thereof. In some embodiments, the one or more communication systems communicate with an external remote control device. In some embodiments, the one or more communication systems receive instructions from the external remote control device, generate signals instructing each of the one or motors to rotate at a speed and in a direction, receive signals from each of the one or more motors regarding motor statuses, and generate a signal informing the external remote control device of the motor statuses. Preferably, the remote control device is a smart phone or tablet, communicating with the controller by Bluetooth

In some embodiments, the lifting apparatus is powered by one or more batteries. In other embodiments, the lifting apparatus is powered by a power line.

The invention has been described with reference to various specific and preferred embodiments and techniques. Nevertheless, it understood that many variations and modifications may be made while remaining within the spirit and scope of the invention.

What is claimed is:

1. A lifting apparatus comprising:
a mounting base;
at least two lateral winches attached to the mounting base, each of the lateral winches comprising a lateral line; and
a lifting winch attached to the mounting base, the lifting winch comprising a lifting line.

2. The invention of claim 1 comprising three lateral winches attached to three different sides of the mounting base

3. The invention of claim 2, wherein the lateral lines of the three lateral winches are each adapted to be attached to a separate elevated point such that the lifting winch can be held above an operating area.

4. The invention of claim 3, further comprising a controller adapted to operate each of the three lateral winches, extending and retracting the lateral lines as appropriate to thereby move the lifting winch to different points above the operating area.

5. The invention of claim 4 wherein the controller is also adapted to control the lifting winch, to thereby enable lifting a load from one location on the operating area, moving the lifted load laterally and then lowering the load to a different location on the operating area.

6. The invention of claim 5, further comprising a top winch attached to the mounting base, the top winch comprising a top line, adapted to be attached to a point above the mounting base to thereby stabilize and control the vertical position of the mounting base.

7. The invention of claim 2, further comprising at least one additional lateral winch.

8. The invention of claim 1, wherein each of the lateral winches and the lifting winch comprise at least one motor and at least one battery powering the at least one motor; and
wherein each of the lateral winches includes burst mode circuitry that enables a burst mode current for a selected duration.

9. The invention of claim 8, wherein at least one of the motors is located in an interior volume of its respective winch.

10. The lifting apparatus of claim 8, further comprising one or more communication systems comprising Bluetooth communication chips, Internet Wi-Fi transceivers, network transceivers, a Z-Wave network transceiver, or a combination thereof, and the one or more communication systems communicate with a remote control device.

11. The lifting apparatus of claim 10, wherein the one or more communication systems receive instructions from the remote control device, generate signals instructing each of the one or motors to rotate at a speed and in a direction, receive signals from each of the one or more motors regarding motor statuses, and generate a signal informing the external remote control device of the motor statuses.

12. The lifting apparatus of claim 1, further comprising one or more batteries, wherein the lifting apparatus is powered by the one or more batteries.

13. The lifting apparatus of claim 1, wherein the lifting apparatus is powered by a power line.

14. The lifting apparatus of claim 1, comprising only two lateral winches and a controller, adapted to controllably extend and retract the lateral lines, as appropriate to move the mounting base in a generally linear path.

15. The invention of claim 14 wherein the controller is also adapted to control the lifting winch, to thereby enable lifting a load from one location on the linear path, moving the lifted load along the linear path and then lowering the load to a different location on the linear path.

16. The lifting apparatus of claim 16, further comprising a top winch attached to a top of the central mounting base, the top winch comprising a top line.

17. A method for moving loads, comprising:
attaching at least two lateral lines from at least two lateral winches to at least two elevated points, the at least two lateral winches mounted to a mounting base;
attaching a lifting line from a lifting winch to a load, the lifting winch mounted to the mounting base;
lifting the load with the lifting winch;
moving the load by extending and retracting the lateral lines, as appropriate; and
lowering the load to a destination.

18. The method of claim 19, further comprising attaching a top line extending from a top winch, which is itself attached to the mounting base, to a point above the mounting base, and thereafter using the top winch to stabilize and control the vertical position of the mounting base.
